(19) United States
(12) Patent Application Publication
(10) Pub. No.: US 2017/0044313 A1
(43) Pub. Date: Feb. 16, 2017

(54) PURIFICATION OF BRINE SOLUTION

(71) Applicant: SABIC Global Technologies B.V., Bergen op Zoom (NL)

(72) Inventor: Ahmed A. YOUSSEF, Mount Vernon, IN (US)

(21) Appl. No.: 15/305,699

(22) PCT Filed: Apr. 29, 2015
(86) PCT No.: PCT/US15/28371

§ 371 Date: Oct. 21, 2016

Related U.S. Application Data
(60) Provisional application No. 61/986,670, filed on Apr. 30, 2014.

(51) Int. Cl. C08G 64/24; C02F 1/461; C02F 1/28; C01D 3/16; C01D 1/04

(52) U.S. Cl. CPC C08G 64/24; C01D 3/16; C01D 1/04; C02F 1/283; C02F 1/461; C02F 2103/38

(57) ABSTRACT

Systems and methods for treatment of an effluent stream are disclosed. In an aspect, a system can comprise an input configured to receive a brine solution, a purification component in communication with the input and configured to receive the brine solution therefrom, the purification component comprising activated carbon, wherein the brine solution is caused to pass through the activated carbon to produce a purified solution, and an output in communication with the purification component to receive the purified solution therefrom.

### BACKGROUND

Certain processes such as the reaction to make polycarbonate generate a byproduct brine stream. The byproduct stream has retained value that can only be claimed if its quality is improved via the removal of various compounds that result from the polymerization reaction. This brings opportunities for various applications including but not limited to the electrolysis process where useful products can be obtained while feeding this purified brine stream. Without the treatment of the brine stream, it becomes a waste and would, further, require risk mitigation before one is able to dispose it. These and other shortcomings of the prior art are addressed by the present disclosure.

### SUMMARY

In accordance with the purpose(s) of the disclosure, as embodied and broadly described herein, in one aspect, relates to a system and process for the purification of a byproduct brine solution generated in a polymerization reaction. In another aspect, the disclosure relates to the treatment and removal of organic compounds to improve the quality and utility of an effluent stream (e.g., brine solution).

In an aspect, systems can comprise an input configured to receive a brine solution. A purification component (e.g., activated carbon bed) can be in communication with the input and configured to receive the brine stream therefrom. The brine stream can be caused to pass through the activated carbon to produce a purified solution. An output can be in communication with the purification component to receive the purified solution therefrom.

In another aspect, methods can comprise receiving a brine solution, wherein the brine solution comprises organic impurities. The brine solution can be caused to pass through a portion of activated carbon, wherein the activated carbon operates to remove at least a portion of one or more of the organic impurities from the brine solution resulting in a purified solution. As an example, the purified solution can have less than about 1 ppm of one or more of bisphenol A, triethyl amine, sebacic acid, methylene chloride, resorcinol, acetone, Q-Salt, n-phenyl phenolphthalein (PPP-BP), phenol, cresols, xylenol, and tetrahydroxypropyl ethylenediamine(THPE).

In a further aspect, methods can comprise reacting bisphenol A and sodium hydroxide to produce polycarbonate and a brine solution, wherein the brine solution comprises one or more organic impurities. The brine solution can be caused to pass through a volume of activated carbon, wherein the activated carbon operates to remove at least a portion of the one or more organic impurities from the brine solution resulting in a purified solution. Electrolysis can be performed on the purified solution to generate sodium hydroxide.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the disclosure, wherein:

FIG. 1 illustrates a schematic of an exemplary system;

FIG. 2 illustrates an exemplary method; and

FIG. 3 illustrates an exemplary method.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DESCRIPTION

The present disclosure can be understood more readily by reference to the following detailed description of the disclosure and the Examples included therein. Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or can not occur, and that the description includes instances where said event or circumstance occurs and instances where it does not.

As used herein, the term “derivative” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds. Exemplary derivatives include salts, esters, amides, salts of esters or amides, and N-oxides of a parent compound.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” or “aliphatic group,” as used herein, denotes a hydrocarbon moiety that may be straight-chain (i.e., unbranched), branched, or cyclic (including fused, bridging, and spirofused polycyclic) and may be completely saturated or may contain one or more units of unsaturation, but which is not aromatic. Unless otherwise specified, aliphatic groups contain 1-20 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. It is understand that the alkyl group is acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C₁ alkyl, C₁-C₂ alkyl, C₁-C₃ alkyl, C₁-C₄ alkyl, C₁-C₅ alkyl, C₁-C₆ alkyl, C₁-C₇ alkyl, C₁-C₈ alkyl, C₁-C₉ alkyl, C₁-C₁₀ alkyl, C₁-C₁₂ alkyl and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The cycloalkyl group can be substituted or unsubstituted. The cycloalkyl group can be substituted with one or more groups including, but not limited to, alkyl, cycloalkyl, alkoxy, amino, ether, halide, hydroxy, nitro, silyl, sulfo-oxo, or thiol as described herein.

The term “polyalkylene group” as used herein is a group having two or more CH₂ groups linked to one another. The polyalkylene group can be represented by the formula (CH₂)ₐ—, where “a” is an integer of from 2 to 500.

The terms “alkoxy” and “alkoxyl” as used herein to refer to an alkyl or cycloalkyl group bonded through an ether linkage; that is, an “alkoxy” group can be defined as OA′ where A¹ is alkyl or cycloalkyl as defined above. “Alkoxy” also includes polymers of alkoxy groups as just described; that is, an alkoxy can be a polyether such as —OA¹-OA² or —OA¹-(OA²)ₐ-OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The cycloalkenyl group can be substituted or unsubstituted. The cycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The cycloalkynyl group can be substituted or unsubstituted. The cycloalkynyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aromatic group” as used herein refers to a ring structure having cyclic clouds of delocalized it electrons above and below the plane of the molecule, where the it clouds contain (4n+2) π electrons. A further discussion of aromaticity is found in Morrison and Boyd, Organic Chemistry, (5th Ed., 1987), Chapter 13, entitled “ Aromaticity,” pages 477-497, incorporated herein by reference. The term “aromatic group” is inclusive of both aryl and heteroaryl groups.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl refers to two aryl groups that are bound together via a fused ring structure, as in naphthalene, or are attached via one or more carbon-carbon bonds, as in biphenyl.

The term “aldehyde” as used herein is represented by the formula —C(O)H. Throughout this specification “C(O)” is a short hand notation for a carbonyl group, i.e., C═O.

In one aspect, the “BPA” is herein defined as bisphenol A and is also known as 2,2-bis (4-hydroxyphenyl) propane, 4, 4′-isopropylidenediphenol and p, p-BPA. As used herein, the term”bisphenol A polycarbonate“refers to a polycarbonate in which essentially all of the repeat units comprise a bisphenol A residue.

The term “carboxylic acid” as used herein is represented by the formula —C(O)OH. The term “dicarboxylic acid” as used herein is represented by formula —HOOC—R—COOH.

The term “ester” as used herein is represented by the formula —OC(O)A¹ or —C(O)OA¹, where A¹ can be alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O)O)ₐ— or -(A¹O(O)C-A²-OC(O))ₐ—, where A¹ and A² can be, independently, an alkyl, cycloalkyl, alkenyl, cycloalkenyl, alkynyl, cycloalkynyl, aryl, or heteroaryl group described herein and “a” is an integer from 1 to 500. “Polyester” is as the term used to describe a group that is produced by the reaction between a compound having at least two carboxylic acid groups with a compound having at least two hydroxyl groups.

The term “ether” as used herein is represented by the formula A¹OA², where A¹ and A² can be, independently, an alkyl, cycloalkyl, alkenyl, cycloalkenyl, alkynyl, cycloalkynyl, aryl, or heteroaryl group described herein. The term “polyether” as used herein is represented by the formula -(A¹O-A²O)ₐ—, where A¹ and A² can be, independently, an alkyl, cycloalkyl, alkenyl, cycloalkenyl, alkynyl, cycloalkynyl, aryl, or heteroaryl group described herein and “a” is an integer of from 1 to 500. Examples of polyether groups include polyethylene oxide, polypropylene oxide, and polybutylene oxide.

The terms “halo,” “halogen,” or “halide,” as used herein can be used interchangeably and refer to F, Cl, Br, or I.

The term “hydroxyl” or “hydroxy” as used herein is represented by the formula —OH.

The term “ketone” as used herein is represented by the formula A¹C(O)A², where A¹ and A² can be, independently, an alkyl, cycloalkyl, alkenyl, cycloalkenyl, alkynyl, cycloalkynyl, aryl, or heteroaryl group as described herein.

The term “azide” or “azido” as used herein is represented by the formula —N₃.

The term “nitro” as used herein is represented by the formula —NO₂.

The term “nitrile” or “cyano” as used herein is represented by the formula —CN.

The term “silyl” as used herein is represented by the formula —SiA¹A²A³, where A¹, A², and A³ can be, independently, hydrogen or an alkyl, cycloalkyl, alkoxy, alkenyl, cycloalkenyl, alkynyl, cycloalkynyl, aryl, or heteroaryl group as described herein.

The term “sulfo-oxo” as used herein is represented by the formulas —S(O)A¹, —S(O)₂A¹, —OS(O)₂A¹, or —OS(O)₂OA¹, where A¹ can be hydrogen or an alkyl, cycloalkyl, alkenyl, cycloalkenyl, alkynyl, cycloalkynyl, aryl, or heteroaryl group as described herein. Throughout this specification “S(O)” is a short hand notation for S═O. The term “sulfonyl” is used herein to refer to the sulfo-oxo group represented by the formula —S(O)₂A¹, where A¹ can be hydrogen or an alkyl, cycloalkyl, alkenyl, cycloalkenyl, alkynyl, cycloalkynyl, aryl, or heteroaryl group as described herein. The term “sulfone” as used herein is represented by the formula A¹S(O)₂A², where A¹ and A² can be, independently, an alkyl, cycloalkyl, alkenyl, cycloalkenyl, alkynyl, cycloalkynyl, aryl, or heteroaryl group as described herein. The term “sulfoxide” as used herein is represented by the formula A¹S(O)A², where A¹ and A² can be, independently, an alkyl, cycloalkyl, alkenyl, cycloalkenyl, alkynyl, cycloalkynyl, aryl, or heteroaryl group as described herein.

The term “thiol” as used herein is represented by the formula —SH.

“R¹,” “R²,” “R³,” “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As described herein, compounds of the disclosure may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this disclosure are preferably those that result in the formation of stable or chemically feasible compounds. In is also contemplated that, in certain aspects, unless expressly indicated to the contrary, individual substituents can be further optionally substituted (i.e., further substituted or unsubstituted).

The term “stable,” as used herein, refers to compounds that are not substantially altered when subjected to conditions to allow for their production, detection, and, in certain aspects, their recovery, purification, and use for one or more of the purposes disclosed herein.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1-26 carbon atoms, 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2-26 carbon atoms, 2 to 18 carbon atoms, 2 to 15 carbon atoms, 2 to 12 carbon atoms, 2 to 8 carbon atoms, 2 to 6 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-thiazolidinedione radical in a particular compound has the structure

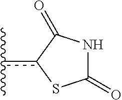

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present disclosure unless it is indicated to the contrary elsewhere herein.

“Organic radicals,” as the term is defined and used herein, contain one or more carbon atoms. An organic radical can have, for example, 1-26 carbon atoms, 1-18 carbon atoms,1 to 15, carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2 to 15 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5, 6, 7, 8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

“Inorganic radicals,” as the term is defined and used herein, contain no carbon atoms and therefore comprise only atoms other than carbon. Inorganic radicals comprise bonded combinations of atoms selected from hydrogen, nitrogen, oxygen, silicon, phosphorus, sulfur, selenium, and halogens such as fluorine, chlorine, bromine, and iodine, which can be present individually or bonded together in their chemically stable combinations. Inorganic radicals have 10 or fewer, or preferably one to six or one to four inorganic atoms as listed above bonded together. Examples of inorganic radicals include, but not limited to, amino, hydroxy, halogens, nitro, thiol, sulfate, phosphate, and like commonly known inorganic radicals. The inorganic radicals do not have bonded therein the metallic elements of the periodic table (such as the alkali metals, alkaline earth metals, transition metals, lanthanide metals, or actinide metals), although such metal ions can sometimes serve as a pharmaceutically acceptable cation for anionic inorganic radicals such as a sulfate, phosphate, or like anionic inorganic radical. Inorganic radicals do not comprise metalloids elements such as boron, aluminum, gallium, germanium, arsenic, tin, lead, or tellurium, or the noble gas elements, unless otherwise specifically indicated elsewhere herein.

Compounds described herein can contain one or more double bonds and, thus, potentially give rise to cis/trans (E/Z) isomers, as well as other conformational isomers. Unless stated to the contrary, the disclosure includes all such possible isomers, as well as mixtures of such isomers.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture. Compounds described herein can contain one or more asymmetric centers and, thus, potentially give rise to diastereomers and optical isomers. Unless stated to the contrary, the present disclosure includes all such possible diastereomers as well as their racemic mixtures, their substantially pure resolved enantiomers, all possible geometric isomers, and pharmaceutically acceptable salts thereof. Mixtures of stereoisomers, as well as isolated specific stereoisomers, are also included. During the course of the synthetic procedures used to prepare such compounds, or in using racemization or epimerization procedures known to those skilled in the art, the products of such procedures can be a mixture of stereoisomers.

Compounds described herein comprise atoms in both their natural isotopic abundance and in non-natural abundance. The disclosed compounds can be isotopically-labelled or isotopically-substituted compounds identical to those described, but for the fact that one or more atoms are replaced by an atom having an atomic mass or mass number different from the atomic mass or mass number typically found in nature. Examples of isotopes that can be incorporated into compounds of the disclosure include isotopes of hydrogen, carbon, nitrogen, oxygen, phosphorous, fluorine and chlorine, such as ²H, ³H, ¹³C, ¹⁴C, ¹⁵N, ¹⁸O, ¹⁷O, ³⁵S, ¹⁸ F and ³⁶Cl, respectively. Compounds further comprise prodrugs thereof, and pharmaceutically acceptable salts of said compounds or of said prodrugs which contain the aforementioned isotopes and/or other isotopes of other atoms are within the scope of this disclosure. Certain isotopically-labelled compounds of the present disclosure, for example those into which radioactive isotopes such as ³H and ¹⁴C are incorporated, are useful in drug and/or substrate tissue distribution assays. Tritiated, i.e., ³H, and carbon-14, i.e., ¹⁴C, isotopes are particularly preferred for their ease of preparation and detectability. Further, substitution with heavier isotopes such as deuterium, i.e., ²H can afford certain therapeutic advantages resulting from greater metabolic stability, for example increased in vivo half-life or reduced dosage requirements and, hence, may be preferred in some circumstances. Isotopically labelled compounds of the present disclosure and prodrugs thereof can generally be prepared by carrying out the procedures below, by substituting a readily available isotopically labelled reagent for a non-isotopically labelled reagent.

The compounds described in the disclosure can be present as a solvate. In some cases, the solvent used to prepare the solvate is an aqueous solution, and the solvate is then often referred to as a hydrate. The compounds can be present as a hydrate, which can be obtained, for example, by crystallization from a solvent or from aqueous solution. In this connection, one, two, three or any arbitrary number of solvent or water molecules can combine with the compounds according to the disclosure to form solvates and hydrates. Unless stated to the contrary, the disclosure includes all such possible solvates.

The term “co-crystal” means a physical association of two or more molecules which owe their stability through non-covalent interaction. One or more components of this molecular complex provide a stable framework in the crystalline lattice. In certain instances, the guest molecules are incorporated in the crystalline lattice as anhydrates or solvates, see e.g. “Crystal Engineering of the Composition of Pharmaceutical Phases. Do Pharmaceutical Co-crystals Represent a New Path to Improved Medicines?” Almarasson, O., et. al., The Royal Society of Chemistry, 1889-1896, 2004. Examples of co-crystals include p-toluenesulfonic acid and benzenesulfonic acid.

It is also appreciated that certain compounds described herein can be present as an equilibrium of tautomers. For example, ketones with an α-hydrogen can exist in an equilibrium of the keto form and the enol form.

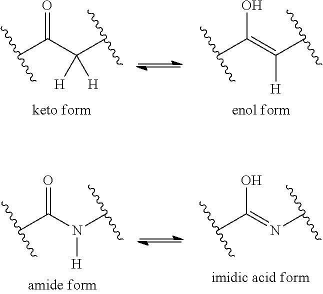 [SMILES: *CC(*)=O ; */C=C(/*)O ; *NC(*)=O ; */N=C(/*)O]

Likewise, amides with an N-hydrogen can exist in an equilibrium of the amide form and the imidic acid form. As another example, pyridinones can exist in two tautomeric forms, as shown below.

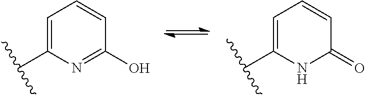 [SMILES: *c1cccc(O)n1 ; *c1cccc(=O)[nH]1]

Unless stated to the contrary, the disclosure includes all such possible tautomers.

It is known that chemical substances form solids which are present in different states of order which are termed polymorphic forms or modifications. The different modifications of a polymorphic substance can differ greatly in their physical properties. The compounds according to the disclosure can be present in different polymorphic forms, with it being possible for particular modifications to be metastable. Unless stated to the contrary, the disclosure includes all such possible polymorphic forms.

In some aspects, a structure of a compound can be represented by a formula:

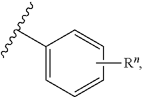

which is understood to be equivalent to a formula:

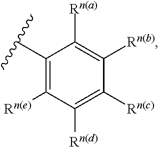

wherein n is typically an integer. That is, Rⁿ is understood to represent five independent substituents, R^{n(a)}, R^{n(b)}, R^{n(c)}, R^{n(d)}, R^{n(e)}. By “independent substituents,” it is meant that each R substituent can be independently defined. For example, if in one instance R^{n(a)} is halogen, then R^{n(b)} is is not necessarily halogen in that instance.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific embodiment or combination of embodiments of the methods of the disclosure.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

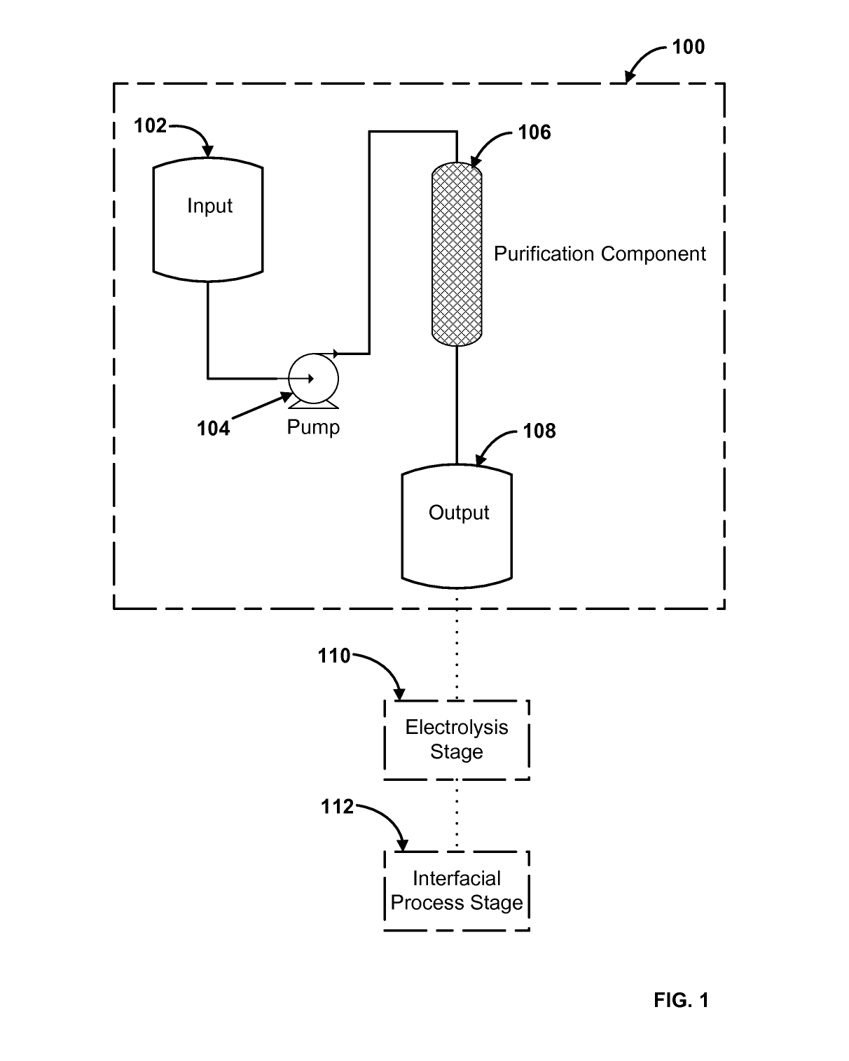

In an aspect, FIG. 1 illustrates a schematic diagram of a system for treatment of effluent streams or other materials. As shown, the system can comprise one or more of a purification stage 100, an electrolysis stage 110, and an interfacial stage 112. Any configuration of stages and components can be implemented. FIG. 1 illustrates an example only and is not intended to limit the configurations of a system embodied by the claims. Additional stages may also be included such as a first and second purification stage, for example.

In an aspect, the purification stage 100 can comprise an input 102, a purification component 106, and an output 108. The input 102 can be or comprise a feed tank, vessel, stirred tank, and/or conduit; or other feed mechanism well known to those skilled in the art. The input 108 can be or comprise a receiving vessel, feed tank for subsequent stage or process, stirred tank, and/or conduit; or other receptacle mechanism well known to those skilled in the art.

The purification component 106 can comprise a volume (e.g., bed, column, etc.) of activated carbon such as reactivated granular carbon (e.g., NORIT® GAC 830R produced by Cabot Corporation). Other activated carbon can be used. As an example, the purification component 106 can be or comprise a treatment vessel such as jacketed glass column enclosing at least a portion of the activated carbon. As shown, the purification component 106 can be disposed in fluid communication with the input 102 and the output 108 to receive a feed stream from the input and to cause a purified stream to flow to the output 108. Other configurations can be implemented.

In an aspect, the brine solution can have a brine strength ranging from about 15 weight percent (wt %) to about 30 wt %. In another aspect, the brine solution can have a brine strength ranging from about 18 wt % to about 25 wt %. Brine strength can be about: 15, 16, 17, 18, 19, 20, 21, 22, 23, 24, 25, 26, 27 28, 29, or 30 wt %. Other brine strength can be used.

In a further aspect, the systems and methods disclosed herein can be applied to solutions having a pH in a range of acidic (about 3) to alkaline (about 10). However, other pH levels can be processed. In another aspect, the systems and methods of the present disclosure can be operated in temperatures ranging from ambient to about 40° C. However, the systems can be operated in other temperature ranges.

The treatment of the brine stream to remove at least a portion of the TOC in the input solution can comprise causing the brine solution to pass through a volume of activated carbon. The treatment process can be operated continuously or otherwise such as batch. If the mode of operation is continuous, then the activated carbon bed can be placed in a column and the brine feed solution can be flowing downwardly. Such configurations are provided as examples and should not be limiting. Consequently, the flow rate of the brine solution can vary and can range from less than 1 Bed Volume/hour to less or equal to 4 Bed Volume/hour.

In an aspect, the brine solutions as contemplated in the present disclosure can be obtained as a by-product of a manufacturing process, such as a condensation polymer manufacturing process. Condensation manufacturing processes that may produce brine as a by-product include, but are not limited to, condensation processes that produce polycarbonates, polyesters, polyarylates, polyamides, polyamideimides, polyetherimides, polyethersulfones, polyetherketones, polyetheretherketones, polyarylene sulfides, polyarylene sulfidesulfones, and the like.

As a non-limiting example, in a polycarbonate production process, for instance, aqueous sodium chloride arises as a by-product when at least one bisphenol is reacted in an organic solvent with phosgene or a carbonate precursor such as an oligomeric carbonate chloroformate in the presence of an aqueous alkaline earth metal hydroxide, such as aqueous sodium hydroxide to produce a polycarbonate.

Representative polycarbonate and polycarbonate copolymers that can be made by such a process include, but are not limited to, bisphenol A polycarbonate; 3, 3′, 5, 5′-tetramethyl bisphenol A polycarbonate; 3, 3′, 5, 5′-tetrabromo bisphenol A polycarbonate, and mixtures thereof.

As an example, the production of polycarbonate from bisphenol A (BPA) takes place according to the following reaction:

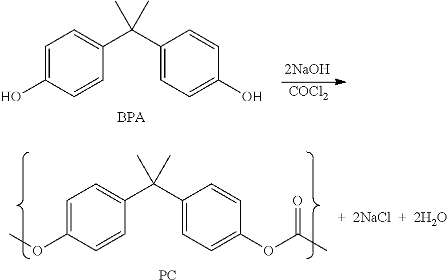

Other copolymers may also be produced when different monomers are utilized as feed materials.

As another example, the byproduct NaCl solution (brine) resulting from the polycarbonate production is typically contaminated with a number of inorganic and organic impurities. As an example, the inorganic impurities can comprise Ca, Mg, and/or Fe for example. As a as another example, the organic impurities can comprise one or more of sodium gluconate, bisphenol A, triethyl amine, sebacic acid, methylene chloride, resorcinol, acetone, n-phenyl phenolphthalein (PPP-BP), phenol, cresols, xylenol, and tetrahydroxypropyl ethylenediamine(THPE). As a further example, the organic impurities can range from less than 10 ppm to about 165 ppm, when the concentration of impurities is measured as a single cumulative value, expressed as total organic carbon (TOC). Table 1 illustrates the general contributions to TOC for a typical brine stream as a byproduct of a polycarbonate polymerization process. Although the present disclosure discusses byproducts of a polymerization process, other processes can provide the solutions for treatment.

TABLE 1

| Component | Formula | Mw* | TOC Contribution |
|---|---|---|---|
| Sodium Gluconate | C₆H₁₁NaO₇ | 218.14 | 0.3304 |
| BPA | C₁₅H₁₆O₂ | 228.29 | 0.7892 |
| Sebacic Acid | C₁₀H₁₈O₄ | 202.25 | 0.5939 |
| Resorcinol | C₆H₆O₂ | 110.11 | 0.6545 |
| Acetone | C₃H₆O | 58.08 | 0.6204 |
| Q-Salt | C₇H₁₇ClNO₃ | 185.91 | 0.4523 |
| PPP-BP | C₂₆H₁₉NO₃ | 393.43 | 0.7938 |

*Mw = weight average molecular weight in grams/mole (actual atom count in the molecule).

In an aspect, the brine stream can either be disposed and no use is made of such valuable byproduct or it could be purified from the above impurities to allow its recovery and reuse. Some existing technologies are limited to effectiveness in removal of the residual monomer (e.g., BPA), which is not optimal for the case where brine quality equivalent to the requirements of membrane technology electrolysis is needed. Moreover, the different nature of the organics in the brine stream poses a challenge to the traditional removal (usually accomplished by adsorbents of the types Ambersorb (various kinds), Amberlite (various kinds).

In another aspect, the brine solution by-product is separated from the condensation polymer product and can be subjected to various treatment steps (e.g., purification stage 100) to increase the concentration of sodium chloride and to remove contaminants. Such purified brine can optionally serve as a feed for the electrolysis stage 110 (e.g., of a chlor-alkali plant).

Suitable electrolysis stages can comprise one or more of a mercury-based component, diaphragm component, membrane component, and oxygen depolarizing cathodes component. Further, the output of the electrolysis stage 110 can be a feed to the interfacial process 112 for the production of polycarbonate. The output of one or more of the purification stage 100, the electrolysis stage 110 and the interfacial process stage 112 can be used in various subsequent processes and is not hereby limited.

Brine solutions, including those arising as by-products from condensation polymer manufacture, can contain both organic and inorganic contaminants. Organic contaminants may include residual solvent, catalyst, and aqueous-soluble organic species such as monomer and low molecular weight oligomer. Inorganic contaminants may include multivalent alkaline earth and transition metal cations, particularly iron. Such contaminants can reduce life and efficiency of components used in the electrolysis stage. Accordingly, reducing the impurities of an input brine stream into the electrolysis stage can improve efficiency and life-time of the components of the electrolysis stage. Furthermore, having a brine solution with reduced impurities can result in an electrolysis output with fewer impurities.

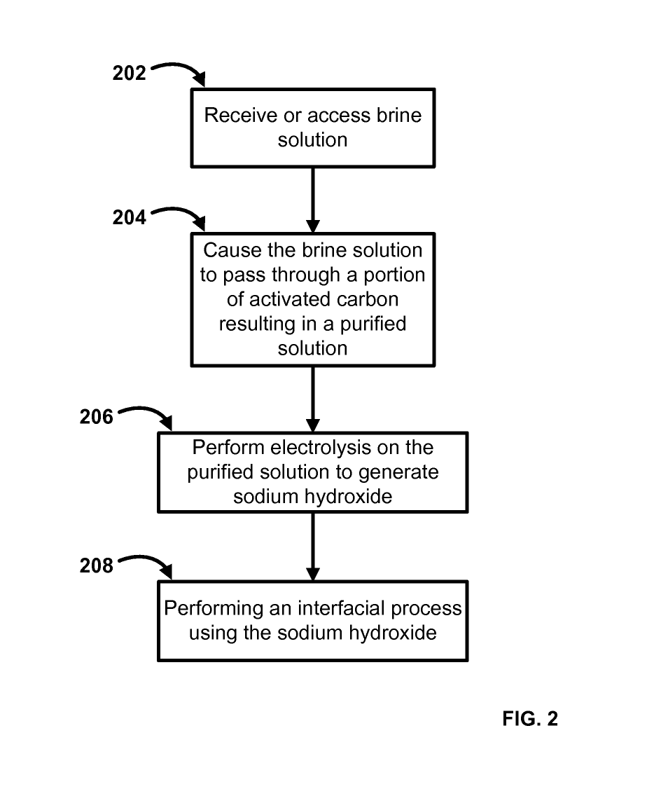

FIG. 2 illustrates an exemplary method for treatment of a solution. At step 202, a brine solution can be received or accessed. In an aspect, the brine solution can comprise organic impurities. At step 204, the brine solution can be caused to pass through a portion of activated carbon. The brine solution can have from about 15 wt % to about 30 wt % sodium chloride. In another aspect, the brine solution can have about 18 wt % to about 25 wt % sodium chloride. The brine solution can have about 15, 16, 17, 18, 19, 20, 21, 22, 23, 24, 25, 26, 27 28, 29, or 30 wt % sodium chloride. The brine solution can be a byproduct of one or more of a polymerization reaction. The brine solution comprises one or more of sodium gluconate, bisphenol A, triethyl amine, sebacic acid, methylene chloride, resorcinol, acetone, n-phenyl phenolphthalein (PPP-BP), phenol, cresols, xylenol, and tetrahydroxypropyl ethylenediamine(THPE). In an aspect, the activated carbon operates to remove at least a portion of one or more of the organic impurities from the brine solution resulting in a purified solution. As an example, the purified solution can have a lower level of total organic carbon than the brine solution. As a further example, the purified solution can have less than 1 ppm of one or more of Bisphenol A, triethyl amine, sebacic acid, methylene chloride, resorcinol, acetone, Q-Salt, n-phenyl phenolphthalein (PPP-BP), phenol, cresols, xylenol, and tetrahydroxypropyl ethylenediamine(THPE).

At step 206, electrolysis can be performed on the purified solution to generate sodium hydroxide (e.g., sodium hydroxide solution). Suitable electrolysis stages can comprise one or more of a mercury-based component, diaphragm component, membrane component, and oxygen depolarizing cathodes component. In an aspect, the sodium hydroxide solution comprises sodium chlorate, sodium carbonate, sodium chloride, or iron, or a combination thereof. As an example, the sodium hydroxide solution can comprise from about 27 to about 35 wt % sodium hydroxide, sodium chlorates below 80 ppm, and iron below 2 ppm. As another example, the sodium hydroxide solution can comprise sodium chlorates below about 20 ppm. As a further example, sodium hydroxide solution can comprise sodium chlorates below about 10 ppm. Other chemistries can be present in similar or different amounts such as sodium carbonate and sodium chloride.

At step 208, an interfacial process can be performed using sodium hydroxide (e.g., from the electrolysis of step 206) to produce polycarbonate.

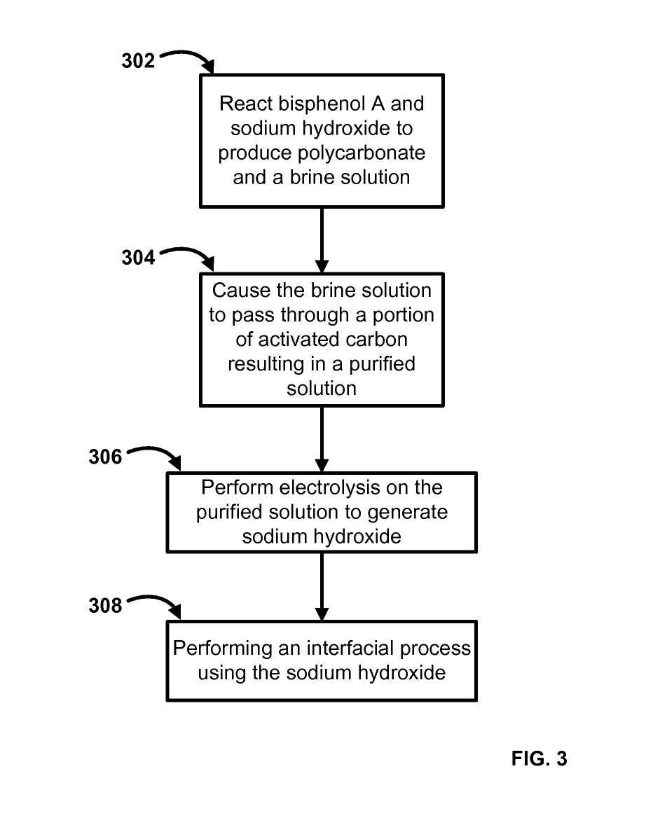

FIG. 3 illustrates an exemplary method for treatment of a solution. At step 302, bisphenol A and sodium hydroxide can be reacted to produce polycarbonate and a brine solution. In an aspect, the brine solution comprises one or more organic impurities. The brine solution can have about 16 wt % to about 25 wt % sodium chloride. The brine solution can be a byproduct of one or more of a polymerization reaction. The brine solution comprises one or more of sodium gluconate, bisphenol A, triethyl amine, sebacic acid, methylene chloride, resorcinol, acetone, n-phenyl phenolphthalein (PPP-BP), phenol, cresols, xylenol, and tetrahydroxypropyl ethylenediamine(THPE).

At step 304, the brine solution can be caused to pass through a volume of activated carbon. In an aspect, the activated carbon operates to remove at least a portion of the one or more organic impurities from the brine solution resulting in a purified solution. As an example, the purified solution can have a lower level of total organic carbon than the brine solution. As a further example, the purified solution can have less than 1 ppm of one or more of Bisphenol A, triethyl amine, sebacic acid, methylene chloride, resorcinol, acetone, Q-Salt, n-phenyl phenolphthalein (PPP-BP), phenol, cresols, xylenol, and tetrahydroxypropyl ethylenediamine(THPE).

At step 306, electrolysis can be performed on the purified solution to generate sodium hydroxide (e.g., sodium hydroxide solution). Suitable electrolysis stages can comprise one or more of a mercury-based component, diaphragm component, membrane component, and oxygen depolarizing cathodes component. In an aspect, the sodium hydroxide solution comprises sodium chlorate, sodium carbonate, sodium chloride, or iron, or a combination thereof. As an example, the sodium hydroxide solution can comprise from about 27 to about 35 wt % sodium hydroxide, sodium chlorates below 80 ppm, and iron below 2 ppm. As another example, the sodium hydroxide solution can comprise sodium chlorates below about 20 ppm. As a further example, sodium hydroxide solution can comprise sodium chlorates below about 10 ppm. Other chemistries can be present in similar or different amounts such as sodium carbonate and sodium chloride. At step 308, an interfacial process can be performed using sodium hydroxide (e.g., from the electrolysis of step 306) to produce polycarbonate.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Several methods for preparing the compounds of this disclosure are illustrated in the following Examples. Starting materials and the requisite intermediates are in some cases commercially available, or can be prepared according to literature procedures or as illustrated herein.

Two types of experimental testing were performed to assess the effectiveness of the treatment of the brine solution, namely, 1) batch mode and 2) continuous mode.

The first type of experimentation was in a batch mode. In this particular example, 18% brine solution was prepared and spiked with various organics compounds and the removal was tested by the inclusion of a weighted amount of carbon (2 grams). In the first set of experiments spiking the solution with BPA was performed (16 ppm batch was prepared for the first test), and a complete removal to below detection limit as achieved (levels of <1 ppm were maintained). Similarly, a batch of brine solution spiked with 90 ppm TEA and similar results were obtained with removal efficiency up to 100%. Moreover, methylene chloride spiked solution exhibited similar behavior and a solution containing >90 ppm was treated down to <1 ppm in the brine solution. The latter, however, was not observed when the spiking was done with sodium gluconate as the brine batches with sodium gluconate (measured as ppm TOC) did not see removal/treatment by the activated carbon employed in the brine solutions.

The second type of experimentation was in a continuous mode of operation using setup shown in FIG. 1. In this case, brine solutions from plant operation/resulting from actual polycarbonate reaction were utilized and levels of organics in the ranges specified in the disclosure's description were present. Similar behavior was proven in a continuous mode of operation where the BPA (and other organics) removal was achieved to levels equivalent to those seen in the batch experiments. However, the total TOC would be limited in removal efficiency due to the presence of sodium gluconate compounds that are not removed by means of the activated carbon.

The disclosed compositions and methods include at least the following aspects.

Aspect 1: A system comprising: an input configured to receive a brine solution; a purification component in communication with the input and configured to receive the brine solution therefrom, the purification component comprising activated carbon, wherein the brine solution is caused to pass through the activated carbon to produce a purified solution; and an output in communication with the purification component to receive the purified solution therefrom.

Aspect 2: The system of aspect 1, wherein the brine solution has about 15% by weight to about 30% by weight sodium chloride.

Aspect 3: The system of aspect 1, wherein the brine solution has about 18% by weight to about 25% by weight sodium chloride.

Aspect 4: The system of any of aspects 1-3, wherein the brine solution is a byproduct of one or more of a polymerization reaction.

Aspect 5: The system of any of aspects 1-4, wherein the brine solution comprises organic impurities.

Aspect 6: The system of any of aspects 1-5, wherein the brine solution comprises one or more of sodium gluconate, bisphenol A, triethyl amine, sebacic acid, methylene chloride, resorcinol, acetone, n-phenyl phenolphthalein, phenol, cresols, xylenol, and tetrahydroxypropyl ethylenediamine.

Aspect 7: The system of any of aspects 1-6, wherein the purified solution has less total organic carbon than the brine solution received by the input.

Aspect 8: The system of any of aspects 1-7, wherein the purified solution has less than about 1 ppm of one or more of bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

Aspect 9: The system of any of aspects 1-8, wherein the temperature in the purification component is between ambient and about 40° C.

Aspect 10: The system of any of aspects 1-9, wherein the brine solution has a pH between about 3 and about 10.

Aspect 11: The system of any of aspects 1-10, further comprising an electrolysis stage configured to receive the purified solution and to output sodium hydroxide solution.

Aspect 12: The system of aspect 11, wherein the output sodium hydroxide solution comprises sodium chlorate, sodium carbonate, sodium chloride, or iron, or a combination thereof.

Aspect 13: The system of aspect 11, wherein the output sodium hydroxide solution comprises from about 27 to about 35 wt % sodium hydroxide, sodium chlorates below 80 ppm, and iron below 2 ppm.

Aspect 14: The system of any of aspects 11-13, wherein the output sodium hydroxide solution comprises sodium chlorates below about 20 ppm.

Aspect 15: The system of any of aspects 11-14, wherein the output sodium hydroxide solution comprises sodium chlorates below about 10 ppm.

Aspect 16: The system of any of aspects 11-15, wherein the electrolysis stage comprises one or more of a mercury-based component, diaphragm component, membrane component, and oxygen depolarizing cathodes component.

Aspect 17: The system of any of aspects 11-16, further comprising an interfacial process stage configured to receive the output sodium hydroxide solution and to output polycarbonate.

Aspect 18: A method (e.g., using the system of any of Aspects 1-17), comprising: receiving a brine solution, wherein the brine solution comprises organic impurities; and causing the brine solution to pass through a portion of activated carbon, wherein the activated carbon operates to remove at least a portion of one or more of the organic impurities from the brine solution resulting in a purified solution, and wherein the purified solution has less than about 1 ppm of one or more of bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

Aspect 19: The method of aspect 18, wherein the brine solution has about 15% by weight to about 25% by weight sodium chloride.

Aspect 20: The method of aspect 18, wherein the brine solution has about 18% by weight to about 25% by weight sodium chloride.

Aspect 21: The method of any of aspects 18-20, wherein the brine solution is a byproduct of one or more of a polymerization reaction.

Aspect 22: The method of any of aspects 18-21, wherein the brine solution comprises one or more of sodium gluconate, bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

Aspect 23: The method of any of aspects 18-22, wherein the purified solution has a lower level of total organic carbon than the brine solution.

Aspect 24: The method of any of aspects 18-23, wherein the brine solution has a pH between about 3 and about 10.

Aspect 25: The method of any of aspects 18-24, further comprising performing electrolysis on the purified solution to generate sodium hydroxide.

Aspect 26: The method of aspect 25, further comprising performing an interfacial process using the sodium hydroxide to produce polycarbonate.

Aspect 27: A method (e.g., using the system of any of Aspects 1-17) comprising: reacting bisphenol A and sodium hydroxide in an interfacial polymerization process to produce polycarbonate and a resultant brine solution, wherein the brine solution comprises one or more organic impurities; causing the brine solution to pass through a volume of activated carbon, wherein the activated carbon operates to remove at least a portion of the one or more organic impurities from the brine solution resulting in a purified solution; performing electrolysis on the purified solution to generate sodium hydroxide solution comprises from about 27 to about 35 wt % sodium hydroxide, sodium chlorates below 80 ppm, and iron below 2 ppm; and using the sodium hydroxide solution to make polycarbonate by an interfacial process.

Aspect 28: The method of aspect 27, wherein the brine solution has about 15 wt % to about 30 wt % sodium chloride.

Aspect 29: The method of aspect 27, wherein the brine solution has about 18% by weight to about 25% by weight sodium chloride.

Aspect 30: The method of any of aspects 27-29, wherein the brine solution comprises one or more of sodium gluconate, bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

Aspect 31: The method of any of aspects 27-30, wherein the purified solution has less total organic carbon than the brine solution.

Aspect 32: The method of any of aspects 27-31, wherein the purified solution has less than 1 ppm of one or more of bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

Aspect 33: The method of any of aspects 27-32, wherein the brine solution has a pH between about 3 and about 10.

Aspect 34: The method of any of aspects 27-33, wherein the flow rate of the brine solution through the volume of activated carbon is from about 1 volume/hour to about 4 volume/hour.

Aspect 35: The method of any of aspects 27-34, wherein the output sodium hydroxide solution comprises sodium chlorates below about 20 ppm.

Aspect 36: The method of any of aspects 27-35, wherein the output sodium hydroxide solution comprises sodium chlorates below about 10 ppm.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A system comprising:
an input configured to receive a brine solution;
a purification component in communication with the input and configured to receive the brine solution therefrom, the purification component comprising activated carbon, wherein the brine solution is caused to pass through the activated carbon to produce a purified solution; and
an output in communication with the purification component to receive the purified solution therefrom.

2. The system of claim 1, wherein the brine solution has about 15% by weight to about 30% by weight sodium chloride, or about 18% by weight to about 25% by weight sodium chloride.

3. The system of claim 1, wherein the brine solution is a byproduct of one or more of a polymerization reaction.

4. The system of claim 1, wherein the brine solution comprises organic impurities.

5. The system of claim 1, wherein the brine solution comprises one or more of sodium gluconate, bisphenol A, triethyl amine, sebacic acid, methylene chloride, resorcinol, acetone, Q-salt, n-phenyl phenolphthalein, phenol, cresols, xylenol, and tetrahydroxypropyl ethylenediamine.

6. The system of claim 1, wherein the purified solution has less total organic carbon than the brine solution received by the input.

7. The system of claim 1, wherein the purified solution has less than about 1 ppm of one or more of bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

8. The system of claim 1, wherein the temperature in the purification component is between ambient and about 40° C.

9. The system of claim 1, wherein the brine solution has a pH between about 3 and about 10.

10. The system of claim 1, further comprising an electrolysis stage configured to receive the purified solution and to output sodium hydroxide solution.

11. The system of claim 10, wherein the output sodium hydroxide solution comprises sodium chlorate, sodium carbonate, sodium chloride, or iron, or a combination thereof.

12. The system of claim 10, wherein the output sodium hydroxide solution comprises from about 27 to about 35 wt % sodium hydroxide, sodium chlorates below 80 ppm, and iron below 2 ppm.

13. The system of claim 10, wherein the output sodium hydroxide solution comprises sodium chlorates below about 20 ppm.

14. The system of claim 10, wherein the output sodium hydroxide solution comprises sodium chlorates below about 10 ppm.

15. The system of claim 10, wherein the electrolysis stage comprises one or more of a mercury-based component, diaphragm component, membrane component, and oxygen depolarizing cathodes component.

16. The system of claim 10, further comprising an interfacial process stage configured to receive the output sodium hydroxide solution and to output polycarbonate.

17. A method comprising:
receiving a brine solution, wherein the brine solution comprises organic impurities; and
causing the brine solution to pass through a portion of activated carbon, wherein the activated carbon operates to remove at least a portion of one or more of the organic impurities from the brine solution resulting in a purified solution, and wherein the purified solution has less than about 1 ppm of one or more of bisphenol A, triethyl amine, sebacic acid, methylene chloride, resorcinol, acetone, Q-Salt, n-phenyl phenolphthalein, phenol, cresols, xylenol, and tetrahydroxypropyl ethylenediamine.

18. The method of claim 17, further comprising performing electrolysis on the purified solution to generate sodium hydroxide.

19. The method of claim 17, further comprising performing an interfacial process using the sodium hydroxide to produce polycarbonate.

20. A method comprising:
reacting bisphenol A and sodium hydroxide in an interfacial polymerization process to produce polycarbonate and a resultant brine solution, wherein the brine solution comprises one or more organic impurities;
causing the brine solution to pass through a volume of activated carbon, wherein the activated carbon operates to remove at least a portion of the one or more organic impurities from the brine solution resulting in a purified solution;
performing electrolysis on the purified solution to generate sodium hydroxide solution comprising from about 27 to about 35 wt % sodium hydroxide, sodium chlorates below 80 ppm, and iron below 2 ppm; and
using the sodium hydroxide solution to make polycarbonate by an interfacial process.
